(19) United States
(12) Patent Application Publication
(10) Pub. No.: US 2026/0051797 A1
(43) Pub. Date: Feb. 19, 2026

(54) ROTOR MANUFACTURING METHOD, AND ROTARY ELECTRIC MACHINE

(71) Applicant: HONDA MOTOR CO., LTD., Tokyo (JP)

(72) Inventors: Daiki Suetsugu, Wako-shi (JP); Shingo Okuno, Wako-shi (JP); Seita Murakawa, Wako-shi (JP)

(21) Appl. No.: 19/211,618

(22) Filed: May 19, 2025

(30) Foreign Application Priority Data
Aug. 13, 2024 (JP) 2024-135060

(51) Int. Cl. H02K 15/035; H02K 1/278

(52) U.S. Cl. CPC H02K 15/035; H02K 1/278

(57) ABSTRACT

A rotor manufacturing method includes: a first magnet-row formation process of forming a magnet row by adjacently arranging and attaching a predetermined plural number of first magnets and a second magnet throughout the whole outer circumference of a rotor core while the rotor core stands on a base flat surface with the magnets brought into abutment against the base flat surface; and a second magnet-row formation process of forming a subsequent magnet row by: inserting and attaching a first magnet to a gap between two first magnets adjacent to the second magnet of the preceding magnet row with the first magnet upwardly protruded from the preceding magnet row; and arranging and attaching the predetermined number of first magnets throughout the whole outer circumference of the rotor core with the magnets brought into abutment against an upper edge of the preceding magnet row in sequence from the preceding magnet row.

### INCORPORATION BY REFERENCE

The present application claims priority under 35 U.S. C. § 119 to Japanese Patent Application No. 2024-135060 filed on Aug. 13, 2024. The content of the application is incorporated herein by reference in its entirety.

### BACKGROUND OF THE INVENTION

### Field of the Invention

The present invention relates to a rotor manufacturing method, and a rotary electric machine.

### Description of the Related Art

Regarding a surface permanent magnet (SPM) motor which includes a rotor having a plurality of magnets disposed on the outer circumferential surface of a rotor core, techniques for fixing the magnets in predetermined positions of the rotor core have been proposed (for example, see Japanese Patent Laid-Open Nos. 2001-157393, 2023-61006, 2015-159639, and 2014-3795). Each of the patent documents discloses a configuration in which the rotor core is provided with a means for positioning the magnets in predetermined positions (groove, insertion hole, projection, pawl, or the like).

To increase the output power (magnetic force) of the SPM rotary electric machine having magnets disposed on the surface of the rotor core which rotates, the rotor needs to be increased in size in the axial and circumferential directions, and due to the long axial and circumferential lengths when the size is increased, a large number of magnets need to be disposed in the axial and circumferential directions. This makes it difficult to position the magnets in the axial and circumferential directions relative to the rotor core, which unfortunately increases man-hours needed for disposing the magnets. Furthermore, if the accuracy of positioning the magnets relative to the rotor core is insufficient, it is difficult to produce a greater magnetic force.

The present application has been made in view of the above background, and an object thereof is to provide a rotor manufacturing method which allows magnets to be positioned on the outer circumferential surface of a rotor core relative to the rotor core with high accuracy through simple processes, and furthermore, to provide a rotary electric machine including a rotor formed with high accuracy through simple processes.

### SUMMARY OF THE INVENTION

According to a first aspect to achieve the above object, in a rotor manufacturing method for manufacturing a rotor suited for a surface permanent magnet (SPM) rotary electric machine by attaching rectangular first magnets and a rectangular second magnet to an outer circumferential surface of a cylindrical rotor core, in which out of two pairs of opposite sides of each of the first magnets, one pair has a first predetermined length whereas another pair has a second predetermined length, and out of two pairs of opposite sides of the second magnet, one pair has the first predetermined length whereas another pair has a third predetermined length shorter than the second predetermined length, the method comprises: a first magnet-row formation process of forming a magnet row for one circumference by adjacently arranging and attaching a predetermined plural number of first magnets out of the first magnets and the second magnet to a lower end of the outer circumferential surface of the rotor core throughout a whole outer circumference of the rotor core while the rotor core stands on a base flat surface with the sides having the first predetermined length brought into abutment against the base flat surface; and a second magnet-row formation process of forming a subsequent magnet row by: inserting and attaching the first magnet to a gap between the two first magnets adjacent to the second magnet of the preceding magnet row formed at a topmost portion with the side having the first predetermined length disposed on a lower side with the first magnet upwardly protruded from the preceding magnet row; and arranging and attaching the predetermined plural number of first magnets in sequence from the first magnet upwardly protruded from the preceding magnet row throughout the whole outer circumference of the rotor core with the sides having the first predetermined length brought into abutment against an upper edge of the preceding magnet row.

In the above-described rotor manufacturing method, the second magnet-row formation process may be performed a plurality of times to cause the subsequent magnet row of the rotor to include two or more magnet rows.

In the above-described rotor manufacturing method, the third predetermined length may be one half of the second predetermined length.

According to a second aspect to achieve the above object, a surface permanent magnet (SPM) rotary electric machine comprises a rotor including rectangular first magnets and a rectangular second magnet attached to an outer circumferential surface of a cylindrical rotor core, wherein out of two pairs of opposite sides of each of the first magnets, one pair has a first predetermined length whereas another pair has a second predetermined length, out of two pairs of opposite sides of the second magnet, one pair has the first predetermined length whereas another pair has a third predetermined length shorter than the second predetermined length, and the rotor includes: a magnet row for one circumference which includes a predetermined plural number of first magnets out of the first magnets and the second magnet adjacently arranged and attached to an outer circumferential surface near one axial end of the rotor core throughout the whole outer circumference of the rotor core with the sides having the first predetermined length aligned with the end; and a subsequent magnet row including: the first magnet inserted and attached to a gap between the two first magnets adjacent to the second magnet of the preceding magnet row with the side having the first predetermined length disposed on a lower side with the first magnet upwardly protruded from the preceding magnet row; and the predetermined plural number of first magnet arranged and attached in sequence from the first magnet upwardly protruded from the preceding magnet row throughout the whole outer circumference of the rotor core with the sides having the first predetermined length brought into contact with an upper edge of the preceding magnet row.

In the above-described rotary electric machine, the rotary electric machine may further comprise a cylindrical stator that includes a flexible circuit board and surrounds the rotor disposed on an inner peripheral side of the stator, wherein the flexible circuit board may include a first sub-circuit board and a second sub-circuit board each including: a strip-shaped flexible insulating sheet; a predetermined number of coil wiring lines that are equal in number to a plurality of phases, extend in a longitudinal direction of the insulating sheet, and are disposed in parallel to each other at intervals; and a connection portion having connection terminals that are equal in number to the coil wiring lines and are each connected to a corresponding one of the coil wiring lines, in which the first sub-circuit board may has the connection portion disposed on a first longitudinal end being one end in the longitudinal direction of the insulating sheet, in which the predetermined number of connection terminals may be connected to an external circuit that supplies drive currents of the plurality of phases in a first connection setting in which the plurality of phases of drive currents supplied from the external circuit to the predetermined number of connection terminals generate a rotating magnetic field in a predetermined direction in the longitudinal direction of the insulating sheet through the coil wiring lines, and the second sub-circuit board may have the connection portion disposed on a second longitudinal end being another end in the longitudinal direction of the insulating sheet, in which the predetermined number of connection terminals may be connected to the external circuit in a second connection setting in which the plurality of phases of drive currents supplied from the external circuit to the predetermined number of connection terminals generate a rotating magnetic field in the predetermined direction in the longitudinal direction of the insulating sheet through the coil wiring lines, and the stator may include the first sub-circuit board and the second sub-circuit board that are bent into a cylindrical shape while being arranged in line along the longitudinal direction of the insulating sheets with the first longitudinal end of the first sub-circuit board and the second longitudinal end of the second sub-circuit board adjacently disposed.

According to the rotor manufacturing method described above, the magnets can be positioned on the outer circumferential surface of the rotor core relative to the rotor core with high accuracy through simple processes. Furthermore, the rotary electric machine including the rotor formed with high accuracy through simple processes can be provided.

### BRIEF DESCRIPTION OF THE DRAWINGS

FIG. 1 is an explanatory diagram of an SPM motor including a rotor manufactured by the rotor manufacturing method according to the present disclosure;

FIG. 2 is an explanatory diagram of the configuration of the rotor illustrated in FIG. 1;

FIG. 3 is an explanatory diagram of two kinds of magnets illustrated in FIG. 2;

FIG. 4 is a first explanatory diagram of a process of manufacturing the rotor;

FIG. 5 is a second explanatory diagram of the process of manufacturing the rotor; and

FIG. 6 is an explanatory diagram of the configuration of a flexible circuit board illustrated in FIG. 1.

### DETAILED DESCRIPTION OF THE INVENTION

### 1. Configuration of Motor

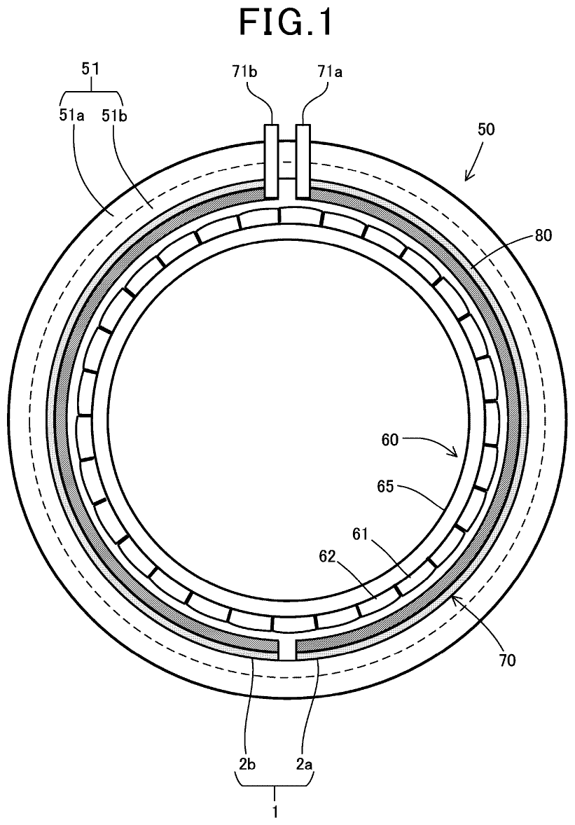

With reference to FIG. 1, the configuration of a motor 50 having a rotor 60 manufactured by the rotor manufacturing method of the present disclosure will be described. The motor 50 (corresponding to the rotary electric machine of the present disclosure) is a surface permanent magnet (SPM) motor. Note that examples of the rotary electric machine having the rotor 60 include not only motors (electromotors) but also power generators and the like.

The motor 50 includes the rotor 60 and a stator 70. The rotor 60 has first magnets 61 and second magnets 62 bonded on the outer circumferential surface. The stator 70 has a flexible circuit board 1 bent into a cylindrical shape and is provided on the outer side of the rotor 60. The flexible circuit board 1 includes a first sub-circuit board 2a and a second sub-circuit board 2b arranged in line and fixed onto the inner peripheral surface of a stator core 51 by means of an adhesive 80, which will be described later in detail. With the stator having the flexible circuit board 1 as described above, the stator can be reduced in weight as compared to a general stator having a conducting wire wound into a coil shape.

With the flexible circuit board 1, the stator 70 can readily have a high density of slots. Due to the high density of slots, the magnetic path of magnetic force generated in a magnet coil of each slot can be shorten, and the thickness of the stator core 51 can be reduced.

Accordingly, the weight per volume of the motor 50 can be reduced. The stator core 51 has an outer peripheral part 51a formed of a nonmagnetic material (Al material or the like), and has an inner peripheral part 51b (back yoke) formed of a magnetic material (Fe material or the like being a soft magnetic material).

### 2. Configuration of Rotor and Rotor Manufacturing Method

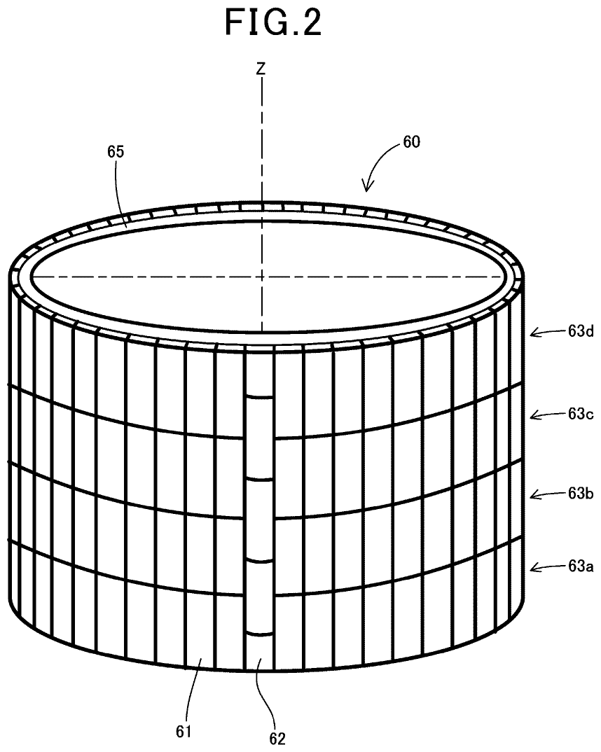

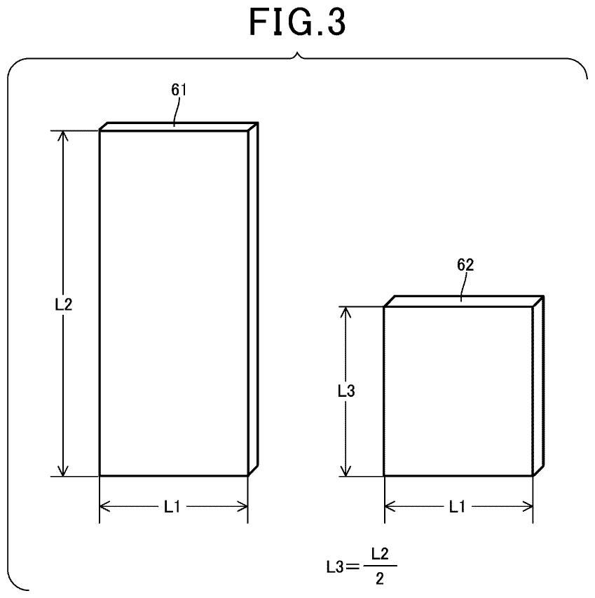

With reference to FIG. 2 and FIG. 3, the configuration of the rotor 60 will be described. As illustrated in FIG. 2, the rotor 60 includes a cylindrical rotor core 65 having an outer circumferential surface on which the first magnets 61 and the second magnet 62 are arranged and bonded throughout the whole circumference to constitute a magnet row 63 for one row. The first magnet 61 differs in length from the second magnet 62. FIG. 2 illustrates an exemplary configuration in which four magnet rows 63a to 63d are disposed on the rotor core 65. In FIG. 2, the axial direction of the rotor 60 is denoted by Z.

As illustrated in FIG. 3, each of the first magnet 61 and the second magnet 62 has a rectangular shape. Out of two pairs of opposite sides of the magnet, one pair has a length of L1 (corresponding to the first predetermined length of the present disclosure). The other pair of the first magnet 61 has a length of L2 (corresponding to the second predetermined length of the present disclosure), whereas the other pair of the second magnet 62 has a length of L3 (corresponding to the third predetermined length of the present disclosure). L3 is one half of L2. As illustrated in FIG. 2, the first magnet 61 and the second magnet 62 are bonded to the outer circumferential surface of the rotor core 65 while the sides having the length of L1 serve as the lower sides as in the state of FIG. 3.

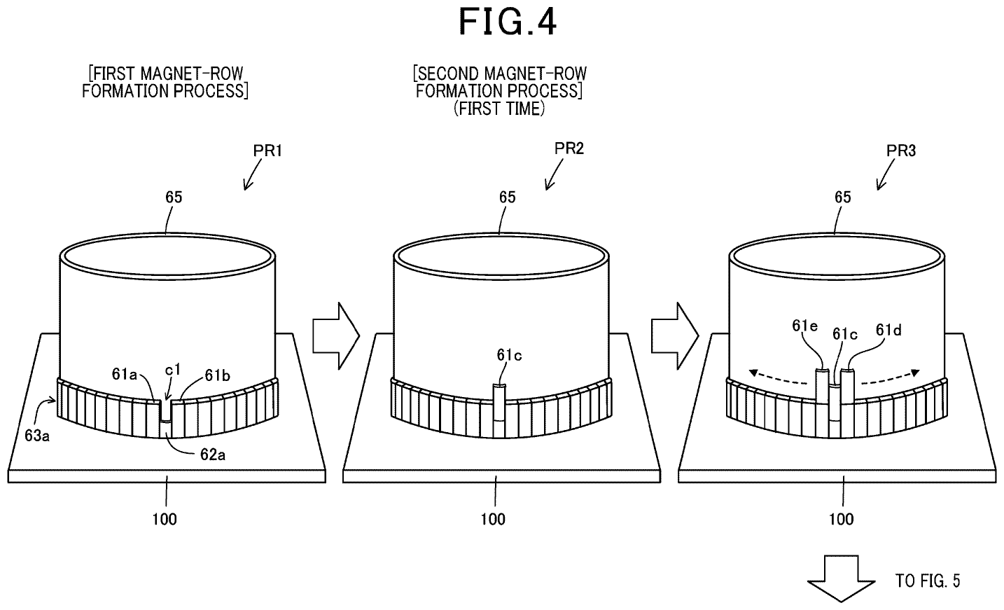

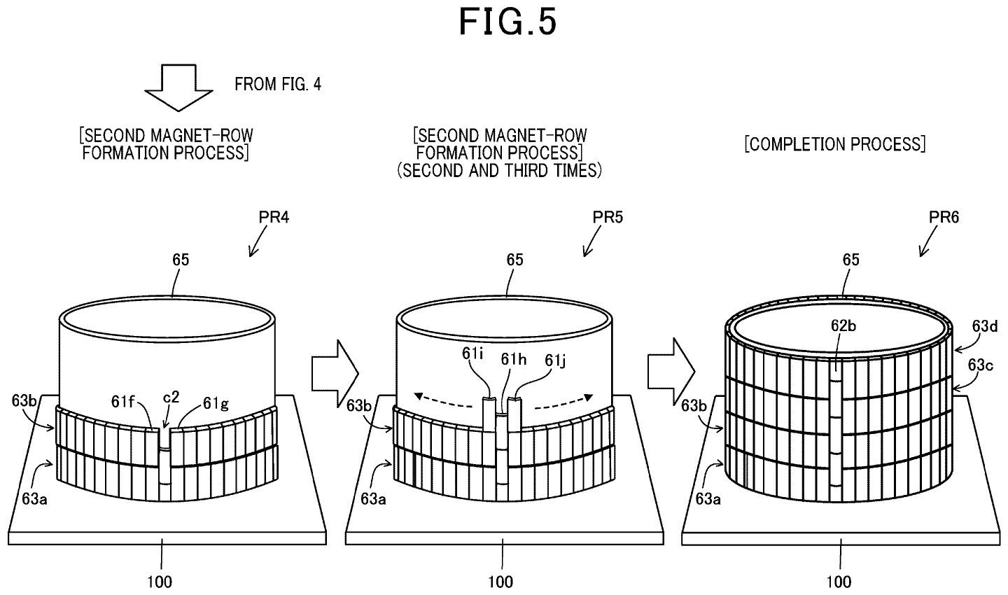

Next, the method of manufacturing the rotor 60 will be described with reference to FIG. 4 and FIG. 5. The rotor 60 is manufactured through processes PR1 to PR6 illustrated in FIG. 4 and FIG. 5, in which the first magnets 61 and the second magnet 62 are disposed and bonded on the outer circumferential surface of the rotor core 65 row by row from the lower end, while the rotor core 65 is placed in a standing posture on a base flat surface 100. The following description will be given for the case where the processes PR1 to PR6 are performed by an operator, but the processes PR1 to PR6 may be performed by a robot.

The process PR1 of FIG. 4 corresponds to the first magnet-row formation process of the present disclosure, in which the operator who manufactures the rotor 60 places the rotor core 65 in a standing posture on the base flat surface 100. The operator then disposes and bonds one second magnet 62a and a predetermined plural number of first magnets 61 on the outer circumference of the rotor core 65 throughout the whole circumference, while lower sides being sides having the length of L1 abut against the base flat surface 100 and the magnets are brought into contact with each other in the circumferential direction. The second magnet 62a and the predetermined plural number of first magnets 61 are equal in circumferential length to the rotor core 65.

With this process, the second magnet 62a and the predetermined number of first magnets 61 are positioned in the axial direction (Z direction illustrated in FIG. 2) by the base flat surface, and are positioned in the circumferential direction by circumferential close contact between the first magnets 61 or between the first magnet 61 and the second magnet 62a. Therefore, the magnets are bonded in a fixed manner on predetermined positions of the rotor core 65 and formed into a first magnet row 63a. In addition, a gap c1 is left between a first magnet 61a and a first magnet 61b which are adjacent to the second magnet 62a due to the difference in axial length between the second magnet 62a and the first magnets 61a and 61b.

The subsequent processes PR2 and PR3, and the process PR4 in FIG. 5 correspond to the second magnet-row formation process of the present disclosure. In the process PR2, the operator inserts a first magnet 61c into the gap c1 of the first magnet row 63a. Since the axial length of the first magnet 61c is longer than that of the second magnet 62a, the upper side of the first magnet 61c protrudes from the first magnet row 63a. The protruding portion of the first magnet 61c serves as a positioning portion for the rotor core 65 with respect to the circumferential direction.

In the subsequent process PR3, the operator arranges and bonds the first magnets 61 in the right and left directions of the figure from the protruding portion of the first magnet 61c as shown by arrows with the protruding portion of the first magnet 61c serving as a starting point, throughout the whole circumference of the rotor core 65. That is, first magnets 61d are sequentially arranged and bonded from the right side of the first magnet 61c, whereas first magnets 61e are sequentially arranged and bonded from the left side of the first magnet 61c, while the magnets are brought into contact with each other in the circumferential direction. With this process, a second magnet row 63b is formed as shown in the next process PR4 of FIG. 5.

In the processes PR3 and PR4, the first magnets 61 constituting the second magnet row 63b are axially positioned by being brought into contact with the first magnet row 63a, and are circumferentially positioned by the first magnet 61c protruding from the first magnet row 63a.

The subsequent processes PR5 and PR6 are second magnet-row formation processes of the second and third times, and therefore the operator performs the same operations as those of the above PR2 to PR4 to form a third magnet row 63c and a fourth magnet row 63d. The second magnet 62b is arranged on the topmost portion of the fourth magnet row 63d.

According to the method of manufacturing the rotor 60 described with reference to FIG. 4 and FIG. 5, the axial length of the rotor 60 can be easily changed by addition or reduction of the number of constituent magnet rows 63. The diameter of the rotor 60 can also be easily changed by addition or reduction of the number of constituent first magnets 61 per row. Therefore, a rotor suited to a large-sized electromotor can be manufactured.

According to the method related to the rotor, due to the abutting of the first magnets 61 and the second magnets 62 against the base flat surface 100, and the contact between the first magnets 61 or contact between the first magnets 61 and the second magnets 62, the first magnets 61 and the second magnets 62 are positioned relative to the rotor core 65. Therefore, since it is not necessary that the rotor core 65, the first magnets 61, or the second magnets 62 be provided with a configuration for positioning the first magnets 61 and the second magnets 62 relative to the rotor core 65, or that equipment for positioning be prepared, the rotor can be manufactured through simple processes.

### 3. Configuration of Flexible Circuit Board

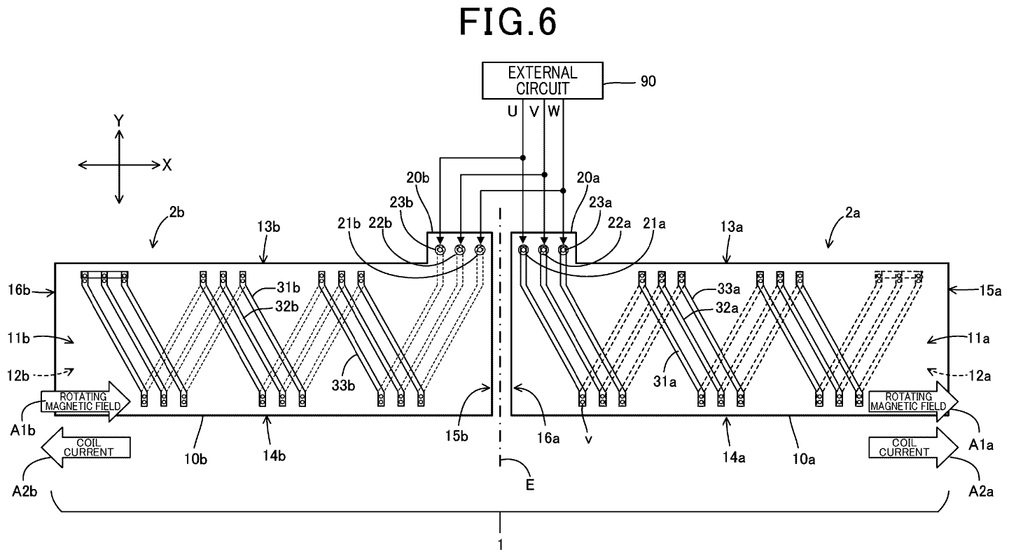

With reference to FIG. 6, the configuration of the flexible circuit board 1 illustrated in FIG. 1 will be described. The flexible circuit board 1 has a configuration similar to that of the flexible circuit board described in Japanese Patent Laid-Open No. 2024-21472, and is manufactured through similar processes. In FIG. 6, the circuit configuration of the flexible circuit board described in the above publication is illustrated in a simplified manner, for the convenience of description.

With reference to FIG. 6, the flexible circuit board 1 includes the first sub-circuit board 2a and the second sub-circuit board 2b arranged in line along the longitudinal direction of the first sub-circuit board 2a and the second sub-circuit board 2b (the longitudinal direction of an insulating sheet 10a constituting the first sub-circuit board 2a and an insulating sheet 10b constituting the second sub-circuit board 2b). In the following description, the longitudinal direction of the first sub-circuit board 2a and the second sub-circuit board 2b will be referred to as an X direction. In addition, the lateral direction of the first sub-circuit board 2a and the second sub-circuit board 2b (the lateral direction of the insulating sheet 10a constituting the first sub-circuit board 2a and the insulating sheet 10b constituting the second sub-circuit board 2b) will be referred to as a Y direction.

The first sub-circuit board 2a includes the insulating sheet 10a, three (corresponding to the predetermined number of the present invention) coil wiring lines 31a, 32a, and 33a, and a connection portion 20a. The insulating sheet 10a is flexible, shaped into a strip, and extends in the right-left direction of the figure. The coil wiring lines 31a, 32a, and 33a are each composed of a plurality of partial wiring lines formed on two opposite principal surfaces (first surface 11a and second surface 12a) of the insulating sheet 10a. The partial wiring lines are connected through vias v each formed at an end in the Y direction. The connection portion 20a has connection terminals 21a, 22a, and 23a to which the coil wiring lines 31a, 32a, and 33a are connected respectively.

The three coil wiring lines 31a, 32a, and 33a intersect each other in a form of a chain without electrical conduction thereamong. In FIG. 6, the wiring lines (conductor pattern) formed on the first surface 11a (front surface) are illustrated by solid lines, whereas the wiring lines formed on the second surface 12a (back surface) are illustrated by broken lines. In the following FIG. 6, FIG. 7, FIG. 8, and FIG. 9 as well, wiring lines formed on the front surface are illustrated by solid lines, whereas the wiring lines formed on the back surface are illustrated by broken lines.

Out of the two sides extending in the X direction of the insulating sheet 10a, the upper side and the lower side illustrated in the figure are referred to as a long side 13a and a long side 14a, respectively. Out of the two sides extending in the Y direction of the insulating sheet 10a, the right side and the left side illustrated in the figure are referred to as a short side 15a and a short side 16a, respectively. In the first sub-circuit board 2a, the connection portion 20a is disposed at an end in the X direction near the short side 16a.

In the first sub-circuit board 2a, the connection portion 20a is connected to an external circuit 90 that supplies drive currents of U, V, and W phases in a connection setting in which the connection terminal 21a, the connection terminal 22a, and the connection terminal 23a correspond to the U phase, V phase, and W phase, respectively. With this setting, the coil current flows as indicated by A2a, that is, from the left to the right of the figure, whereas the rotating magnetic field is directed as indicated by A1a, that is, from the left to the right of the figure.

The second sub-circuit board 2b is a reversed version of the first sub-circuit board 2a, which is obtained by reversing the first surface 11a and the second surface 12a about an axis E along the Y direction, and includes the insulating sheet 10b, and coil wiring lines 31b, 32b, and 33b and a connection portion 20b formed on the insulating sheet 10b as in the first sub-circuit board 2a.

Regarding the second sub-circuit board 2b, out of the two sides extending in the X direction of the insulating sheet 10b, the upper side and the lower side illustrated in the figure are referred to as a long side 13b and a long side 14b, respectively. Out of the two sides extending in the Y direction of the insulating sheet 10b, the right side and the left side illustrated in the figure are referred to as a short side 15b and a short side 16b, respectively.

The connection portion 20b is disposed at an end in the X direction near the short side 16b (corresponding to the second longitudinal end of the present disclosure) of the second sub-circuit board 2b. The connection portion 20b is connected to the external circuit 90 that supplies drive currents of U, V, and W phases in a connection setting in which the connection terminal 23b, the connection terminal 22b, and the connection terminal 21b correspond to the U phase, V phase, and W phase, respectively. With this setting, the coil current flows as indicated by A2b, that is, from the right (from the short side 15b) to the left (to the short side 16b) of the figure, whereas the rotating magnetic field is directed as indicated by A1b, that is, from the left to the right of the figure.

Namely, the direction of the rotating magnetic field generated in the first sub-circuit board 2a is the same as the direction of the rotating magnetic field generated in the second sub-circuit board 2b. Therefore, the rotor can rotate normally. Note that the connection terminal 23b, the connection terminal 22b, and the connection terminal 21b of the connection portion 20b of the second sub-circuit board 2b may be connected to external terminals of the three phases of U, V, and W in a connection setting in which the connection terminal 23b, the connection terminal 22b, and the connection terminal 21b correspond to the W phase, U phase, and V phase, respectively, or in which the connection terminal 23b, the connection terminal 22b, and the connection terminal 21b correspond to the V phase, W phase, and U phase, respectively. With these settings, the direction of the magnetic field generated in the second sub-circuit board 2b is the same as the direction of the magnetic field generated in the first sub-circuit board 2a.

In addition, since the connection portion 20a of the first sub-circuit board 2a and the connection portion 20b of the second sub-circuit board 2b are adjacent to each other, a first external terminal 71a to be connected to the connection portion 20a and a second external terminal 71b to be connected to the connection portion 20b can be disposed adjacent to each other. This allows the motor 50 and the external circuit 90 to be connected at one portion, which facilitates distribution of wiring lines.

Although FIG. 6 illustrates an example where the single first sub-circuit board 2a and the single second sub-circuit board 2b constitute the stator, a long-sized flexible circuit board, which can be a constituent of a stator suited for a large-sized motor, can be easily formed from a plurality of flexible circuit boards 1 each including a pair of first sub-circuit board 2a and second sub-circuit board 2b arranged in line along the X direction as illustrated in FIG. 1.

By combination of the rotor 60 which can have a large diameter and a stator having the plurality of flexible circuit boards 1 each including the pair of first sub-circuit board 2a and second sub-circuit board 2b as described above, a large-sized rotary electric machine can be manufactured through an operation of simple processes.

### 4. Other Embodiments

According to the above embodiment, the length L3 corresponding to the axial direction of the rotor core 65 (hereinafter referred to as an axial length) of the side of the second magnet 62 is one half of the axial length L2 of the first magnet 61, as illustrated in FIG. 2. In this case, it is sufficient that one kind of the second magnet 62 be prepared. As another embodiment, the axial length L3 of the second magnet 62 may be any length shorter than the axial length L2 of the first magnet 61 other than the length being one half of the axial length L2. In this case, it is necessary to prepare two kinds of second magnets having different axial lengths, that is, the total axial length of the second magnet 62 arranged in the first magnet row and the second magnet 62 arranged in the topmost magnet row need to be L2.

Although the flexible circuit board 1 including the first sub-circuit board 2a and the second sub-circuit board 2b has been described in the above embodiment, a flexible circuit board composed of a single board may be the constituent of the rotary electric machine such as the motor 50.

### 5. Configurations Supported by the Above Embodiments

The above embodiments are specific examples of the following configurations.
(Configuration 1) A rotor manufacturing method for manufacturing a rotor suited for a surface permanent magnet (SPM) rotary electric machine by attaching rectangular first magnets and a rectangular second magnet to an outer circumferential surface of a cylindrical rotor core, in which out of two pairs of opposite sides of each of the first magnets, one pair has a first predetermined length whereas another pair has a second predetermined length, and out of two pairs of opposite sides of the second magnet, one pair has the first predetermined length whereas another pair has a third predetermined length shorter than the second predetermined length, the method comprising: a first magnet-row formation process of forming a magnet row for one circumference by adjacently arranging and attaching a predetermined plural number of first magnets out of the first magnets and the second magnet to a lower end of the outer circumferential surface of the rotor core throughout a whole outer circumference of the rotor core while the rotor core stands on a base flat surface with the sides having the first predetermined length brought into abutment against the base flat surface; and a second magnet-row formation process of forming a subsequent magnet row by: inserting and attaching the first magnet to a gap between the two first magnets adjacent to the second magnet of the preceding magnet row formed at a topmost portion with the side having the first predetermined length disposed on a lower side with the first magnet upwardly protruded from the preceding magnet row; and arranging and attaching the predetermined plural number of first magnets in sequence from the first magnet upwardly protruded from the preceding magnet row throughout the whole outer circumference of the rotor core with the sides having the first predetermined length brought into abutment against an upper edge of the preceding magnet row.

According to the rotor manufacturing method of Configuration 1, the magnets can be positioned on the outer circumferential surface of the rotor core relative to the rotor core with high accuracy through simple processes in manufacturing the rotor.
(Configuration 2) The rotor manufacturing method according to Configuration 1, wherein the second magnet-row formation process is performed a plurality of times to cause the subsequent magnet row of the rotor to include two or more magnet rows.

According to the rotor manufacturing method of Configuration 2, a rotor having a large size in the axial direction can be manufactured by arranging two or more subsequent magnet rows on the rotor core.
(Configuration 3) The rotor manufacturing method according to Configuration 1 or 2, wherein the third predetermined length is one half of the second predetermined length.

According to the rotor manufacturing method of Configuration 3, the rotor can be manufactured with use of one kind of second magnet.
(Configuration 4) A surface permanent magnet (SPM) rotary electric machine comprising: a rotor including rectangular first magnets and a rectangular second magnet attached to an outer circumferential surface of a cylindrical rotor core, wherein out of two pairs of opposite sides of each of the first magnets, one pair has a first predetermined length whereas another pair has a second predetermined length, out of two pairs of opposite sides of the second magnet, one pair has the first predetermined length whereas another pair has a third predetermined length shorter than the second predetermined length, and the rotor includes: a magnet row for one circumference which includes a predetermined plural number of first magnets out of the first magnets and the second magnet adjacently arranged and attached to an outer circumferential surface near one axial end of the rotor core throughout the whole outer circumference of the rotor core with the sides having the first predetermined length aligned with the end; and a subsequent magnet row including: the first magnet inserted and attached to a gap between the two first magnets adjacent to the second magnet of the preceding magnet row with the side having the first predetermined length disposed on a lower side with the first magnet upwardly protruded from the preceding magnet row; and the predetermined plural number of first magnet arranged and attached in sequence from the first magnet upwardly protruded from the preceding magnet row throughout the whole outer circumference of the rotor core with the sides having the first predetermined length brought into contact with an upper edge of the preceding magnet row.

According to the rotary electric machine of Configuration 4, a rotary electric machine including a rotor formed with high accuracy due to its simple configuration can be formed.
(Configuration 5) The rotary electric machine according to Configuration 4, further comprising a cylindrical stator that includes a flexible circuit board and surrounds the rotor disposed on an inner peripheral side of the stator, wherein the flexible circuit board includes a first sub-circuit board and a second sub-circuit board each including: a strip-shaped flexible insulating sheet; a predetermined number of coil wiring lines that are equal in number to a plurality of phases, extend in a longitudinal direction of the insulating sheet, and are disposed in parallel to each other at intervals; and a connection portion having connection terminals that are equal in number to the coil wiring lines and are each connected to a corresponding one of the coil wiring lines, in which the first sub-circuit board has the connection portion disposed on a first longitudinal end being one end in the longitudinal direction of the insulating sheet, in which the predetermined number of connection terminals are connected to an external circuit that supplies drive currents of the plurality of phases in a first connection setting in which the plurality of phases of drive currents supplied from the external circuit to the predetermined number of connection terminals generate a rotating magnetic field in a predetermined direction in the longitudinal direction of the insulating sheet through the coil wiring lines, and the second sub-circuit board has the connection portion disposed on a second longitudinal end being another end in the longitudinal direction of the insulating sheet, in which the predetermined number of connection terminals are connected to the external circuit in a second connection setting in which the plurality of phases of drive currents supplied from the external circuit to the predetermined number of connection terminals generate a rotating magnetic field in the predetermined direction in the longitudinal direction of the insulating sheet through the coil wiring lines, and the stator includes the first sub-circuit board and the second sub-circuit board that are bent into a cylindrical shape while being arranged in line along the longitudinal direction of the insulating sheets with the first longitudinal end of the first sub-circuit board and the second longitudinal end of the second sub-circuit board adjacently disposed.

According to the rotary electric machine of Configuration 5, the flexible circuit board including a combination of the first sub-circuit board and the second sub-circuit board arranged in line is employed, so that the rotary electric machine includes the stator which can readily have a large size in the circumferential direction and the rotor which has a plurality of first magnets being arranged and thus can readily have a large size in the circumferential direction, and therefore the rotary electric machine which can have a large size in the circumferential direction can be formed.

### Reference Signs List

1: Flexible circuit board, 2a: First sub-circuit board, 2b: First sub-circuit board, 10a, 10b: Insulating sheet, 20a, 20b: Connection portion, 21a to 23a, 21b to 23b: Connection terminal, 31a to 33a, 31b to 33b: Coil wiring line, 50: Motor, 51: Stator core, 60: Rotor, 61: First magnet, 62: Second magnet, 63: Magnet row, 65: Rotor core, 70: Stator, 80: Adhesive, 100: Base flat surface

1. A rotor manufacturing method for manufacturing a rotor suited for a surface permanent magnet (SPM) rotary electric machine by attaching rectangular first magnets and a rectangular second magnet to an outer circumferential surface of a cylindrical rotor core, in which
out of two pairs of opposite sides of each of the first magnets, one pair has a first predetermined length whereas another pair has a second predetermined length, and
out of two pairs of opposite sides of the second magnet, one pair has the first predetermined length whereas another pair has a third predetermined length shorter than the second predetermined length,
the method comprising:
a first magnet-row formation process of forming a magnet row for one circumference by adjacently arranging and attaching a predetermined plural number of first magnets out of the first magnets and the second magnet to a lower end of the outer circumferential surface of the rotor core throughout a whole outer circumference of the rotor core while the rotor core stands on a base flat surface with the sides having the first predetermined length brought into abutment against the base flat surface; and
a second magnet-row formation process of forming a subsequent magnet row by: inserting and attaching the first magnet to a gap between the two first magnets adjacent to the second magnet of the preceding magnet row formed at a topmost portion with the side having the first predetermined length disposed on a lower side with the first magnet upwardly protruded from the preceding magnet row; and arranging and attaching the predetermined plural number of first magnets in sequence from the first magnet upwardly protruded from the preceding magnet row throughout the whole outer circumference of the rotor core with the sides having the first predetermined length brought into abutment against an upper edge of the preceding magnet row.

2. The rotor manufacturing method according to claim 1, wherein
the second magnet-row formation process is performed a plurality of times to cause the subsequent magnet row of the rotor to include two or more magnet rows.

3. The rotor manufacturing method according to claim 1, wherein
the third predetermined length is one half of the second predetermined length.

4. A surface permanent magnet (SPM) rotary electric machine comprising: a rotor including rectangular first magnets and a rectangular second magnet attached to an outer circumferential surface of a cylindrical rotor core, wherein
out of two pairs of opposite sides of each of the first magnets, one pair has a first predetermined length whereas another pair has a second predetermined length,
out of two pairs of opposite sides of the second magnet, one pair has the first predetermined length whereas another pair has a third predetermined length shorter than the second predetermined length, and
the rotor includes:
a magnet row for one circumference which includes a predetermined plural number of first magnets out of the first magnets and the second magnet adjacently arranged and attached to an outer circumferential surface near one axial end of the rotor core throughout the whole outer circumference of the rotor core with the sides having the first predetermined length aligned with the end; and
a subsequent magnet row including: the first magnet inserted and attached to a gap between the two first magnets adjacent to the second magnet of the preceding magnet row with the side having the first predetermined length disposed on a lower side with the first magnet upwardly protruded from the preceding magnet row; and the predetermined plural number of first magnet arranged and attached in sequence from the first magnet upwardly protruded from the preceding magnet row throughout the whole outer circumference of the rotor core with the sides having the first predetermined length brought into contact with an upper edge of the preceding magnet row.

5. The rotary electric machine according to claim 4, further comprising a cylindrical stator that includes a flexible circuit board and surrounds the rotor disposed on an inner peripheral side of the stator, wherein
the flexible circuit board includes
a first sub-circuit board and a second sub-circuit board each including: a strip-shaped flexible insulating sheet; a predetermined number of coil wiring lines that are equal in number to a plurality of phases, extend in a longitudinal direction of the insulating sheet, and are disposed in parallel to each other at intervals; and a connection portion having connection terminals that are equal in number to the coil wiring lines and are each connected to a corresponding one of the coil wiring lines, in which
the first sub-circuit board has the connection portion disposed on a first longitudinal end being one end in the longitudinal direction of the insulating sheet, in which the predetermined number of connection terminals are connected to an external circuit that supplies drive currents of the plurality of phases in a first connection setting in which the plurality of phases of drive currents supplied from the external circuit to the predetermined number of connection terminals generate a rotating magnetic field in a predetermined direction in the longitudinal direction of the insulating sheet through the coil wiring lines, and
the second sub-circuit board has the connection portion disposed on a second longitudinal end being another end in the longitudinal direction of the insulating sheet, in which the predetermined number of connection terminals are connected to the external circuit in a second connection setting in which the plurality of phases of drive currents supplied from the external circuit to the predetermined number of connection terminals generate a rotating magnetic field in the predetermined direction in the longitudinal direction of the insulating sheet through the coil wiring lines, and
the stator includes the first sub-circuit board and the second sub-circuit board that are bent into a cylindrical shape while being arranged in line along the longitudinal direction of the insulating sheets with the first longitudinal end of the first sub-circuit board and the second longitudinal end of the second sub-circuit board adjacently disposed.
